(19) United States
(12) Patent Application Publication
(10) Pub. No.: US 2009/0146964 A1
(43) Pub. Date: Jun. 11, 2009

(54) TOUCH SENSING DISPLAY DEVICE AND DRIVING METHOD THEREOF

(76) Inventors: Jong-Woung Park, Seongnam-si (KR); Won-Seok Ma, Seongnam-si (KR); Hyung-Guel Kim, Yongin-si (KR); Sung-Woo Lee, Suwon-si (KR); Joo-Hyung Lee, Gwacheon-si (KR); Byung-Ki Jeon, Seoul (KR); Kee-Han Uh, Yongin-si (KR)

Correspondence Address: Haynes and Boone, LLP;IP Section, 2323 Victory Avenue, SUITE 700, Dallas, TX, 75219, US

(21) Appl. No.: 12/167,733

(22) Filed: Jul. 3, 2008

(30) Foreign Application Priority Data
Dec. 10, 2007 (KR) 10-2007-0127679

(51) Int. Cl. G06F 3/041; G09G 5/00

(52) U.S. Cl. 345/173; 345/211

(57) ABSTRACT

In a touch sensing display device, a plurality of sensor scanning lines extend in a first direction and sequentially receive a first voltage, and a plurality of sensor data lines extend in a second, different, direction. A plurality of sensing elements are formed in regions defined by the sensor scanning lines and the sensor data lines, and each sensing element transmits the first voltage from a corresponding sensor scanning line to a corresponding sensor data line responsive to an external touch. A sensing signal processor converts voltages of the sensor data lines into sensing data, and, a touch determining unit processes the sensing data corresponding to the sensor scanning lines by at least one scanning line to determine positions of touch regions generated during at least one frame.

### CROSS-REFERENCE TO RELATED APPLICATION

This application claims priority to and the benefit of Korean Patent Application No. 10-2007-0127679 filed in the Korean Intellectual Property Office on Dec. 10, 2007, the entire contents of which are incorporated herein by reference.

### BACKGROUND OF THE INVENTION

(a) Field of the Invention

The present invention relates to a display device and a driving method thereof. More particularly, the present invention relates to a touch sensing display device and a driving method thereof.

(b) Description of the Related Art

Generally, display devices include a plurality of pixels arranged in a matrix, and images are displayed by controlling the light intensities of each pixel according to given luminance information. A liquid crystal display device in particular, includes a pixel electrodes display panel, a common electrode display panel, and a liquid crystal layer with dielectric anisotropy positioned between the two display panels. In a liquid crystal display, when a voltage is applied to the two electrodes, an electric field is generated in the liquid crystal layer. The intensity of the electric field can be adjusted to control the transmittance of light through the liquid crystal layer, and obtaining a desired image.

Recently, products in which a sensing element is adapted to the display device have been developed. Such sensing elements detect changes in pressure or light generated by a touch such as by a user's finger or a touch pen, and then provide electrical signals indicating the touch to the display device. The display device can detect whether or not a touch occurs, or determine the location of the touch based on the electrical signals. This sensing element is provided as an external device such as a touch screen and may be attached to the display device, but as a result, the thickness and the weight of the liquid crystal display are increased. Such sensing element also increases the difficulty in displaying minute characters or pictures.

To solve these problems, the sensing element can alternatively be built inside of the liquid crystal display as opposed to being an external device. These sensing elements are arranged in a row direction and a column direction, and sensing signals are output from the sensing element at the position where a touch is sensed.

However, when several positions are simultaneously touched, causing multiple sensing elements to produce sensing signals during a short interval, much processing time and a large memory capacity are required.

The above information disclosed in this Background section is only for enhancement of understanding of the background of the invention and therefore it may contain information that does not form the prior art that is already known in this country to a person of ordinary skill in the art.

### SUMMARY OF THE INVENTION

In accordance with one embodiment of the present invention is to provide a display device and a driving method thereof to reduce the processing time for detecting touch positions of a sensing element.

In accordance with one embodiment of the present invention is to provide a display device and a driving method thereof to detect touch positions of a sensing element with a small memory capacity.

A display device according to an exemplary embodiment of the present invention includes a plurality of sensor scanning lines, a plurality of sensor data lines, a plurality of sensing elements, a sensing signal processor, and a touch determining unit. The sensor scanning lines are extended in a first direction and sequentially receive a first voltage, and the sensor data lines are extended in a second, different, direction. The sensing elements are respectively formed in regions defined by the sensor scanning lines and the sensor data lines, and transmit the first voltage from an associated sensor scanning line among the plurality of sensor scanning lines to an associated sensor data line among the plurality of sensing data lines responsive to an external touch. The sensing signal processor converts voltages of the sensor data lines into sensing data, and the touch determining unit processes the sensing data for at least one scanning line, wherein one scanning line of sensing data is generated by sensing elements connected to one of the plurality of scanning lines, to determine positions of touch regions generated during at least one frame.

The display device may further include a plurality of sensor gate lines, an sensor scanning driver, and a plurality of switching elements. The sensor scanning driver may sequentially transmit a gate-on voltage to the sensor gate lines. Each switching element has an input terminal connected to a signal line for supplying the first voltage, a control terminal connected to the sensor gate line, and an output terminal connected to the sensor scanning line, and is turned on in response to the gate-on voltage transmitted to the control terminal.

The touch determining unit may include a sensing data reader configured to receive and store the sensing data of at least one scanning line from the sensing signal processor, and a touch position determining unit configured to read the sensing data of at least one scanning line stored in the sensing data reader to determine the positions of the touch regions. After the touch position determining unit reads the sensing data of the at least one scanning line, the sensing data reader may receive and store the sensing data of at least one next scanning line from the sensing signal processor.

The touch position determining unit may determine the number of touch regions generated during at least one frame and the position of each touch region.

The sensing signal processor may maintain a voltage of a sensor data line not receiving the first voltage with a second voltage that is different from the first voltage, and convert the first voltage of the sensor data lines into sensing data of a first value and convert the second voltage of the sensor data lines into the sensing data of a second value.

The sensing signal processor may include a plurality of resistors one o f which is connected between each of the sensor data lines and a voltage source supplying the second voltage.

The touch determining unit may determine a first start position and a first end position in the second direction of each touch region generated during at least one frame, and determine a representative value of the first start position and the first end position as a position in the second direction.

The touch determining unit may determine a representative position in each scanning line corresponding to each touch region, and determine a representative value of the representative positions in scanning lines corresponding to each touch region as a position in the first direction.

The touch determining unit may determine a second start position and a second end position in each scanning line of each touch region, and determine a representative value of the second start position and the second end position as the representative position of each scanning line.

The representative value may be an average value.

The touch determining unit may determine a position at which the sensing data is changed from the second value to the first value in each scanning line as the second start position, and determine a position at which the sensing data is changed from the first value to the second value as the second end position.

The touch position determining unit may search the sensing data in an order of the first direction to determine the first start position and the first end position of each touch region.

The touch position determining unit may determine a position of a scanning line at which the representative position is firstly determined in each touch region as the first start position.

The touch position determining unit may determine a previous scanning line as the first end position when the sensing data of a current scanning line corresponding to the representative position of the previous scanning line in each touch region is the second value.

When the first end position is not determined in each touch region and at least one among the sensing data of a current scanning line respectively corresponding to the second start position, the second end position, and the representative position of a previous scanning line is the first value, the touch position determining unit may determine the representative position of the current scanning line to be within the same touch region as the representative position of the previous scanning line.

According to another exemplary embodiment of the present invention, a method of driving a display device including a plurality of sensor scanning lines extending in a first direction, a plurality of sensor data lines extending in a second direction, and a plurality of sensing elements formed in regions defined by the sensor scanning lines and the sensor data lines and connected to a corresponding sensor scanning line and a corresponding sensor data line is provided. The method includes sequentially applying a reference voltage to the sensor scanning lines, transmitting the reference voltage from a sensor scanning line connected to a sensing element corresponding to an external touch to a sensor data line connected to the sensing element, converting voltages of the sensor data lines into sensing data, and determining positions of touch regions generated during one frame by processing the sensing data by one scanning line.

The conversion of the voltages may include generating a sensing data having a first value when the voltage of a sensor data line is the reference voltage, and generating a sensing data having a second value when the voltage of a sensor data line is not the reference voltage.

The determination of the positions may include searching the sensing data sequentially the first direction to detect a start position of a first touch region, determining a position of the first touch region in the second direction, and determining a position of the first touch region in the first direction.

The determination of the position in the second direction may include determining a first start position and a first end position of the first touch region in the second direction, and determining a representative value of the first start position and the first end position as the position of the first touch region in the second direction. The determination of the position in the first direction may include determining a representative position in each scanning line of the first touch region, and determining a representative value of the representative positions of the first touch region in scanning lines as the position of the first touch region in the first direction.

The determination of the representative position may include determining a second start position and a second end position of the first touch region in each scanning line, and determining a representative value of the second start position and the second end position as the representative position.

The determination of the second start position and the second end position may include determining a position at which the sensing data is changed from the second value to the first value in each scanning line of the first touch region as the second start position, and determining a position at which the sensing data is changed from the first value to the second value in each scanning line of the first touch region as the second end position.

The determination of the first start position and the first end position may include determining a scanning line at which the representative position is firstly determined in the first touch region as the first start position.

The determination of the first start position and the first end position may include determining a previous scanning line as the first end position when the sensing data of a current scanning line corresponding to the representative position of the previous scanning line in the first touch region is the second value.

The determination of the positions may further include determining the representative position of a current scanning line to be included in the first touch region if at least one among the sensing data of the current scanning line corresponding to the second start position, the second end position, and the representative position of a previous scanning line has the first value when the first end position is not determined in the first touch region,.

The determination of the positions may further include determining the representative position of a current scanning line to be included to a second touch region that is different from the first touch region if the sensing data of the current scanning line corresponding to the second start position, the second end position, and the representative position of a previous scanning line have the second value when the first end position is not determined in the first touch region.

According to an exemplary embodiment of the present invention, whether a touch is generated such that a touch region of one sensor frame can be recognized is sequentially determined by a processing data for each scanning line, and a sensing signal of a region at which the touch is detected and a sensing signal of a region at which the touch is not detected are determined through the voltage of the sensor data line, thereby determining a position of the touch region.

According to an exemplary embodiment of the present invention, the number of touch regions generated during one sensor frame and the position of each touch region can be independently determined, and the positions of the touch regions can be determined by two line buffers as a substitution for a frame buffer.

Also, the positions of all touch regions generated during one sensor frame can be determined during sequential processing of the sensing data of one sensor frame by scanning lines, thereby reducing the processing time required for the determination of the touch region position.

### BRIEF DESCRIPTION OF THE DRAWINGS

FIG. 1 is a block diagram of a liquid crystal display according to an exemplary embodiment of the present invention.

FIG. 2 is an equivalent circuit diagram of one pixel in the liquid crystal display according to an exemplary embodiment of the present invention.

FIG. 3 is a block diagram of a portion of the liquid crystal display according to an exemplary embodiment of the present invention.

FIG. 4 is an equivalent circuit diagram of a sensing element in the liquid crystal display according to an exemplary embodiment of the present invention.

FIG. 5 is a cross-sectional view of the sensing element of FIG. 4.

FIG. 6 is a schematic circuit diagram showing one example of a pull-up resistor of the sensing signal processor shown in FIG. 1 and FIG. 3.

FIG. 7 is a block diagram of a touch determining unit according to an exemplary embodiment of the present invention.

FIG. 8 is a block diagram of a touch position determining unit according to an exemplary embodiment of the present invention.

FIG. 9 is a flowchart showing a method for determining the touch position in the touch position determining unit shown in FIG. 8.

FIG. 10 is a flowchart showing a method for determining a starting position and an ending position of an x-axis in the touch position determining unit of FIG. 8.

FIG. 11 is a flowchart showing a method for determining a representative position of the x-axis and a starting position of a y-axis in the touch position determining unit shown in FIG. 8.

FIG. 12A and FIG. 12B are flowcharts showing a method for determining an ending position of a y-axis in the touch position determining unit shown in FIG. 8.

FIG. 13 is a flowchart showing a method for determining a touch region position in the touch position determining unit shown in FIG. 8.

### DETAILED DESCRIPTION OF THE EMBODIMENTS

In the following detailed description, only certain exemplary embodiments of the present invention are shown and described as an illustration of the present invention.

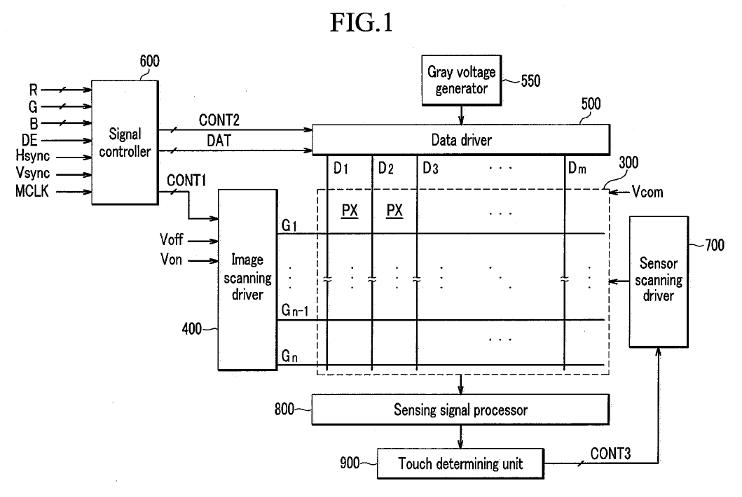

Firstly, a touch sensing display device according to an exemplary embodiment of the present invention is described in detail with the reference to FIG. 1 to FIG. 6. Specifically, a liquid crystal display is described as one example of the display device according to an exemplary embodiment of the present invention.

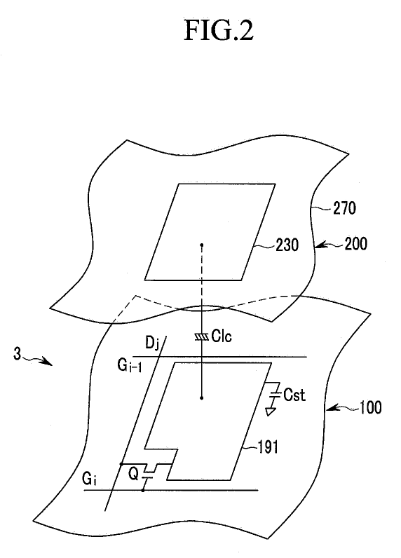

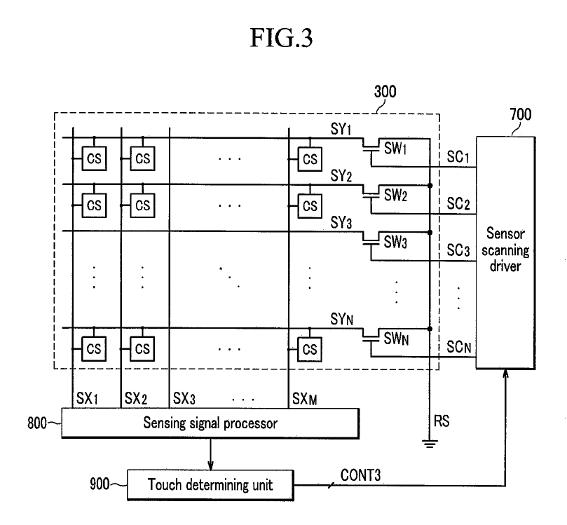

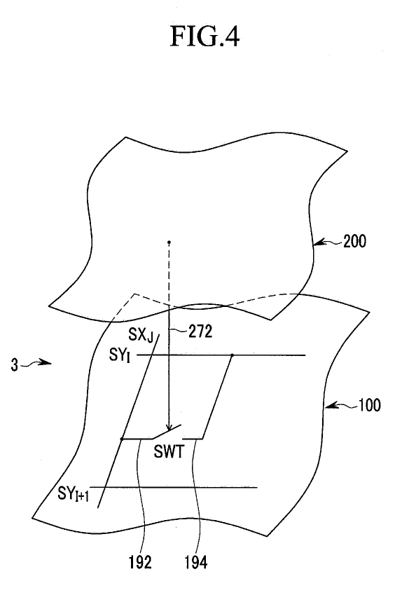

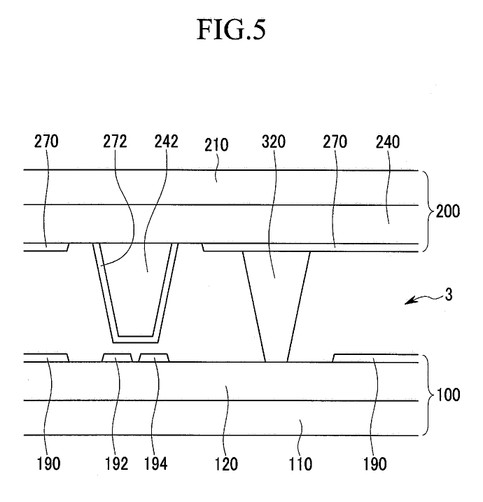

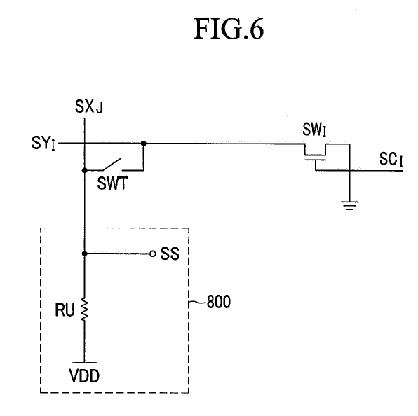

FIG. 1 is a block diagram of a liquid crystal display according to an exemplary embodiment of the present invention, FIG. 2 is an equivalent circuit diagram of one pixel in the liquid crystal display according to an exemplary embodiment of the present invention, FIG. 3 is a block diagram of a portion of the liquid crystal display according to an exemplary embodiment of the present invention, FIG. 4 is an equivalent circuit diagram of a sensing element in the liquid crystal display according to an exemplary embodiment of the present invention, FIG. 5 is a cross-sectional view of the sensing element of FIG. 4, and FIG. 6 is a schematic circuit diagram showing one example of a pull-up resistor of the sensing signal processor shown in FIG. 1 and FIG. 3.

As shown in FIG. 1, a liquid crystal display according to an exemplary embodiment of the present invention includes a liquid crystal panel assembly 300, an image scanning driver 400, a data driver 500, a gray voltage generator 550, a signal controller 600, a sensor scanning driver 700, a sensing signal processor 800, and a touch determining unit 900.

With reference to FIG. 1 and FIG. 3, the liquid crystal panel assembly 300 includes a plurality of display signal lines G₁-Gₙ and D₁-Dₘ ; a plurality of pixels PX connected with the plurality of display signal lines G₁-Gₙ and D₁-Dₘ and arranged substantially in a matrix form; a plurality of sensor signal lines SY₁-SY_{N}, SX₁-SX_{M}, and SC₁-SC_{N}; a plurality of sensing elements CS connected with the sensor signal lines SY₁-SY_{N}, SX₁-SX_{M} and SC₁-SC_{N} and arranged substantially in a matrix form; and a plurality of switching elements SW₁-SW_{N} connected to end portions of the sensor signal lines SY₁-SY_{N}.

The display signal lines G₁-Gₙ and D₁-Dₘ include a plurality of image gate lines G₁-Gₙ for transferring image gate signals (image scanning signals) and a plurality of image data lines D₁-Dₘ for transferring image data signals. The image gate lines G₁-Gₙ extend substantially in a row direction to run almost parallel to each other, and the image data lines D₁-Dₘ extend substantially in a column direction to run almost parallel to each.

Referring to FIG. 1 and FIG. 2, each pixel PX, for example a pixel PX, connected to an i-th image gate line Gᵢ (i=1, 2, . . . , n) and a j-th image data line Dⱼ (j=1, 2, . . . , m), includes a switching element Q connected to the display signal lines Gi and Dj, and an liquid crystal capacitor Clc and a storage capacitor Cst that are connected to the switching element Q. The storage capacitor Cst can be omitted if necessary.

The switching element Q is a three terminal element such as a thin film transistor provided in a thin film transistor array panel 100. The switching element Q has a control terminal which is connected to the image gate line Gᵢ, a input terminal which is connected to the image data line Dⱼ, and a output terminal which is connected to the pixel electrode 191 which is one plate of the liquid crystal capacitor Clc and the storage capacitor Cst.

The liquid crystal capacitor Clc uses a pixel electrode 191 of a lower display panel 100 and a common electrode 270 of an upper display panel 200 as two terminals, and uses the liquid crystal layer 3 between the two electrodes 191 and 270 as a dielectric material. The pixel electrode 191 is connected to the switching element Q while the common electrode 270 is formed on the whole surface of the upper display panel 200 and applied with a common voltage Vcom. Alternatively, the common electrode 270 may be provided on the lower display panel 100, and at least one of the two electrodes 191 and 270 may have a line shape or a bar shape.

The storage capacitor Cst is an auxiliary capacitor for the liquid crystal capacitor Clc. The storage capacitor Cst includes the pixel electrode 191 and a separate signal line (not shown). The separate signal line is provided on the lower display panel 100, overlapping the pixel electrode 191 via an insulator, and is supplied with a predetermined voltage such as the common voltage Vcom. Alternatively, the storage capacitor Cst includes the pixel electrode 191 and an adjacent image gate line called a previous image gate line Gᵢ₋₁, which overlaps the pixel electrode 191 via an insulator.

For color display, each pixel PX may uniquely represents one of primary colors (i.e., spatial division) or sequentially represents the primary colors in turn (i.e., temporal division), such that spatial or temporal sum of the primary colors is recognized as a desired color. An example of a set of the primary colors includes red, green, and blue colors. FIG. 2 shows an example of the spatial division in which each pixel PX includes a color filter 230 representing one of the primary colors in an area of the upper display panel 200 facing the pixel electrode 191. Alternatively, the color filter 230 may be provided on or under the pixel electrode 191 on the lower display panel 100.

At least one polarizer (not shown) for polarizing the light is attached on the outer side of the liquid crystal panel assembly 300.

Again referring to FIG. 1 and FIG. 3, the sensor signal lines include a plurality of sensor scanning lines SY₁-SY_{N} for transmitting sensor scanning signals, a plurality of sensor data lines SX₁-SX_{M} for transmitting sensing signals, a plurality of sensor gate lines SC₁-SC_{N} for transmitting sensor gate signals, and a reference signal line RS. The sensor scanning lines SY₁-SY_{N} extend substantially in a row direction and almost parallel to each other, and the sensor data line SX₁-SX_{M} extend substantially in a row direction and almost parallel to each other.

Here, the number N of the sensor scanning lines SY₁-SY_{N} is less than the number n of the image gate lines G₁-Gₙ, and the number M of the sensor data lines SX₁-SX_{M} is less than the number m of the image data lines D₁-Dₘ. For example, it may be determined that the numbers N and M of the sensor scanning lines SY₁-SY_{N} and the sensor data lines SX₁-SX_{M} are respectively one quarter of the numbers n and m of the image gate lines G₁-Gₙ and the image data lines D₁-Dₘ. Thus, one sensing element CS may be disposed for every four pixels in the row direction and the column direction.

Each switching element SW₁-SW_{N} may be a three-terminal element provided in the lower display panel 100, such as a thin film transistor. The switching element SW₁-SW_{N} has a control terminal and an input terminal respectively connected to the sensor gate lines SC₁-SC_{N} and the end portion of the reference signal line RS, and an output terminal connected to the sensor scanning lines SY₁-SY_{N}. The other end portion of the reference signal line RS is connected to a power source (for example, a ground terminal) for supplying a reference voltage. Accordingly, each switching elements SW₁-SW_{N} transmits the reference voltage (for example, a ground voltage) to the corresponding sensor scanning lines SY₁-SY_{N} from the reference signal line RS in response to the sensor gate signals transmitted to the sensor gate lines SC₁-SCN.

Referring to FIG. 4, each sensing elements CS, for example the sensing element CS connected to the I-th (I=1, 2, . . . , N) sensor scanning line SY_{I} and the J-th (I=1, 2, . . . , M) sensor data line SX_{J}, includes a sensing switch SWT.

The sensing switch SWT includes a control terminal connected to the sensor electrode 272 on the upper display panel 200, an input terminal connected to the sensor scanning line SY_{I} and, and an output terminal connected to the sensor data line SXⱼ on the lower display panel 100. Here, a touch electrode 194 extending from the sensor scanning line SY_{I} and a touch electrode 192 extending from the sensor data line SXⱼ may form the input terminal and the output terminal of the sensing switch SWT respectively.

As shown in FIG. 5, a pixel layer 120 including the image gate lines G₁-Gₘ, the image data lines D₁-Dₘ, and the switching elements Q is formed on a substrate 110 made of transparent glass or plastic to form the lower display panel 100. The two touch electrodes 194 and 192 which are connected to the sensor data line SX_{J} and the sensor scanning line SY_{I} are formed on the lower display panel 100. The pixel electrode 190 may be formed with the touch electrodes 192 and 194.

The upper display panel 200 faces the lower display panel 100, and includes a substrate 210 made of transparent glass or plastic, and a color filter layer 240. The color filter layer 240 includes a light blocking member, a color filter, and an overcoat formed on the substrate 210. A plurality of protrusions 242 protruding downward are formed on the color filter layer 240 in the regions corresponding to the touch electrodes 192 and. The protrusions 242 may extend from the color filter layer 240.

The common electrode 270 occupies the region that the protrusions 242 do not occupy in the color filter layer 240, and sensor electrodes 272 are formed on the protrusions 242. A plurality of column spacers 320 are formed between the common electrode 270 and the pixel layer 120. The column spacers 320 are uniformly dispersed in the liquid crystal panel assembly 300 and support the lower display panel 100 and the upper display panel 200 to form a gap therebetween.

Referring to FIG. 4 and FIG. 5, the sensing switch SWT, which is the sensing element CS, comes into contact with the sensor electrode 272 with the two touch electrodes 192 and 194 in response to a pressure on the upper display panel 200. Thus, the two touch electrodes 192 and 194 becomes electrically connected, and the reference voltage transmitted through the sensor scanning line SX_{I} is output as the sensing signal SS through the sensor data line SY_{J}.

Referring again to FIG. 1 and FIG. 3, the gray voltage generator 550 generates all gray voltages or a predetermined number of gray voltages (or reference gray voltages) related to transmittance of the pixels PX. The reference gray voltages may include one set having a positive value for a common voltage Vcom, and another set having a negative value.

The image scanning driver 400 is connected to the image gate lines G1-Gn of the liquid crystal panel assembly 300 to apply an image gate signal consisting of a combination of a gate-on voltage Von for turning on the switching element Q and a gate-off voltage Voff for turning off the switching element Q to the image gate lines G1-Gn. For example, when the switching element Q is an n-channel transistor, the gate-on voltage Von is a high voltage and the gate-off voltage Voff is a low voltage.

The image data driver 500 is connected to the image data lines D1-Dm of the liquid crystal panel assembly 300. The image data driver 500 selects a gray voltage from the gray voltage generator 550 and applies the gray voltage as an image data signal to the image data lines D1-Dm. When the gray voltage generator 550 does not supply voltages for all values of grays and only supplies a predetermined number of reference gray voltages, the image data driver 500 divides the reference gray voltages provided to generate image data signals.

The signal controller 600 controls the operations of the image scanning driver 400, the image data driver 500, and the gray voltage generator 550.

The sensor scanning driver 700 is connected to the sensor gate lines SC₁-SC_{N} of the liquid crystal panel assembly 300. The sensor scanning driver 700 applies the sensor gate signal consisting of a combination of a gate-on voltage and a gate-off voltage to the sensor gate lines SC₁-SC_{N}. Here, the gate-on voltage and the gate-off voltage are voltages to turn the switching elements SW₁-SW_{N} on and off, and may have the same value as the gate-on voltage Von and the gate-off voltage Voff of the image gate signal.

The sensing signal processor 800 is connected to the sensor data lines SX₁-SX_{M} of the liquid crystal panel assembly 300. The sensing signal processor 800 receives sensing signal SS from the sensor data lines SX₁-SX_{M} and performs signal processing to generate a digital sensing signal.

Referring to FIG. 6, the sensing signal processor 800 includes a plurality of pull-up resistors RU connected to the sensor data lines SX₁-SX_{M} one-on-one. A pull-up resistor RU connected to the J-th sensor data line SX_{J} is shown in FIG. 6. Each pull-up resistor RU is connected between the sensor data line SX_{J} and a voltage source VDD. A sensing signal SS is outputted through the junction point of the sensor data line SX_{J} and the pull-up resistor RU. Here, when the sensing element CS, that is, the sensing switch SWT, is turned on by a touch and the switching element SW_{I} is turned on by the sensor gate signal, the sensing signal SS has the reference voltage value (ground voltage). In the absence of a touch, the sensing signal SS has the voltage of the voltage source VDD through the pull-up resistor RU.

Thus, the sensing signal processor 800 generates a sensing data representing a touch in response to the sensing signal SS of the reference voltage, and a sensing data representing a non-touch in response to the sensing signal SS of the voltage VDD. For example, the sensing data DS is determined as ‘0’ when a touch occurs, and the sensing data DS is determined as ‘1’ in when no touch occurs.

The touch determining unit 900 can be formed as a central processing unit (CPU) which receives the sensing data DS from the sensing signal processor 800 and determines whether the sensing element CS has been touched or not and determine the position of the touch region. The touch determining unit 900 outputs the sensor control signal CONT3 to the sensor scanning driver 700 to control the operation of the sensor scanning driver 700.

The sensor control signal CONT3 includes a sensor scanning start signal STVi which triggers scanning and at least one sensor clock signal CLKi which controls the output period of the gate-on voltage. Thus, the sensor scanning driver 700 sequentially applies the gate-on voltage to the sensor gate lines SC₁-SC_{N} in response to the sensor scanning start signal STVi to sequentially turn on the switching elements SW₁-SW_{N}.

In the liquid crystal display according to an exemplary embodiment of the present invention, the sensing signals generated by touches are sequentially outputted according to the sensor gate signals per row unit, thereby outputting the sensing signals in one complete sensing frame. Also, in the liquid crystal display according to an exemplary embodiment of the present invention, the sensing signal of the region where a touch is detected and the sensing signal of the region where a touch is not detected are determined through the voltage of the sensor data line, thereby determining the position of the touch region.

Each of the driving elements 400, 500, 550, 600, 700, and 800 may be integrated into at least one IC chip and mounted in the liquid crystal panel assembly 300, mounted on a flexible printed circuit film (not shown) and then be adhered to the liquid crystal panel assembly 300 in a tape carrier package (TCP), or mounted in a printed circuit board (PCB) (not shown). Alternatively, the driving elements 400, 500, 550, 600, 700, and 800 may be integrated with the liquid crystal panel assembly 300 along with the signal lines G₁-G_{N}, D₁-Dₘ, SY₁-SY_{N}, and SX₁-SX_{M}, the thin film transistor Q and/or the like.

The operation of the liquid crystal display device disclosed above is described below in detail.

The signal controller 600 receives input image signals R, G, and B, and an input control signal to control the display of the image signals R, G, and B from a graphics controller (not shown). The input image signals R, G, and B contains luminance information of each pixel (PX). The luminance information has a predetermined number of grays, such as 1024 (=2¹⁰), 256 (=2⁸), or 64 (=2⁶). Examples of the input control signals may include a vertical synchronization signal Vsync, a horizontal synchronizing signal Hsync, a main clock signal MCLK, a data enable signal DE, and the like.

The signal controller 600 processes the input image signals R, G, and B based on the input control signal to be suitable for the operating conditions of the liquid crystal panel assembly 300. The signal controller 600 generates a gate control signal CONT1, a data control signal CONT2, and so on, and sends the gate control signal CONT1 to the image scanning driver 400, and the data control signal CONT2 and a processed image signal DAT to the image data driver 500.

The gate control signal CONT1 includes a scanning start signal STV to trigger scanning and at least one clock signal to control the output cycle of the gate-on voltage Von. The gate control signal CONT1 may further include an output enable signal OE to define the duration of the gate-on voltage Von. Here, the period of the image scanning start signal STV may be the same or different from the period of the sensing scanning start signal STVi.

The data control signal CONT2 includes a horizontal synchronization start signal STH informing of the transmission start of image data for a row [group] of pixels PX, a load signal LOAD to instruct the image data signal to be applied to the image data lines (D1-Dm), and a data clock signal HCLK. The data control signal CONT2 may further include an inversion signal RVS to invert the voltage polarity of the image data signal for the common voltage Vcom (hereinafter, “the voltage polarity of the image data signal for the common voltage” is abbreviated to “the polarity of the image data signal”).

The image data driver 500 receives digital image signals DAT for a row [group] of pixels PX according to the data control signal CONT2 transmitted from the signal controller 600, and selects a grayscale voltage corresponding to each digital image signal DAT to convert the digital image signals DAT into analog data voltages (image data signals). Thereafter the data driver 500 applies the converted analog data voltages to corresponding image data lines D₁ to Dₘ.

The image scanning driver 400 applies the gate-on voltage Von to the image gate lines G₁ to Gₙ according to the gate control signal CONT1 transmitted from the signal controller 600 to turn on switching elements Q connected to the image gate lines G₁ to Gₙ. Then, the image data signals applied to the data lines D₁ to Dₘ are applied to corresponding pixels PX through the turned-on switching elements Q.

A difference between the voltage of the image data signal applied to the pixels PX and the common voltage Vcom appears as a charged voltage of the liquid crystal capacitor Clc, that is, a pixel voltage. Alignment of the liquid crystal molecules varies according to the magnitude of the pixel voltage and changes the polarization of light passing through the liquid crystal layer 3. The transmittance of the light is changed by to the change in the polarization of a polarizer attached to the liquid crystal panel assembly 300 such that the pixel PX displays the luminance corresponding to the gray of the image signals DAT.

In one horizontal period 1H which is the same as one period of the horizontal synchronization signal Hsync and the data enable signal DE, the aforementioned operations are repeatedly performed to sequentially apply the gate-on voltages Von to all the image gate lines G₁ to Gₙ so that the image data signals are applied to all the pixels PX. As a result, one frame of the image is displayed.

When one frame ends the next frame starts, and the reverse signal RVS applied to the image data driver 500 is controlled so that the voltage polarity of the image data signal applied to each of the pixels is opposite to the voltage polarity of the previous frame (frame inversion). At this time, even in one frame, the voltage polarity of the image data signal flowing through the one image data line may be inverted according to the characteristics of the reverse signals RVS (row inversion and dot inversion). In addition, the voltage polarities of the image data signals applied to the one pixel row may be different from each other (column inversion and dot inversion).

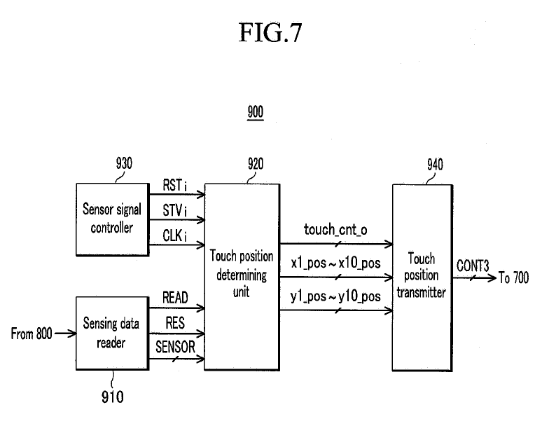

Next, a liquid crystal display and a processing method of the sensing signal of an exemplary embodiment of the present invention is described below with reference to FIG. 7 to FIG. 13. Hereafter, it is exemplified that the row direction of FIG. 3 is the x-axis direction and the column direction is the y-axis direction.

FIG. 7 is a block diagram of a touch determining unit 900 according to an exemplary embodiment of the present invention.

Referring to FIG. 7, the touch determining unit 900 includes a sensing data reader 910, a sensor signal controller 930, a touch position determining unit 920, and a touch position transmitter 940.

The sensing data reader 910 receives the sensing data corresponding to one row from the sensing signal processor 800 to store them to a line buffer (not shown), and transmits a read signal READ indicating that the sensing data have been stored to the line buffer, to the touch position determining unit 920. Then, the touch position determining unit 920 reads the sensing data SENSOR stored in the line buffer of the sensing data determining unit 910 in response to the read signal READ. Also, the sensing data determining unit 910 transmits a resolution signal RES representing a resolution x_res of an x-axis direction and a resolution y_res of a y-axis direction to the touch position determining unit 920.

The sensor signal controller 930 transmits the sensor scanning start signal STVi and the sensor clock signal CLKi, and an initialization signal RSTi for initialization, to the touch position determining unit 920 to control the operation of the touch position determining unit 920. The sensor scanning start signal STVi and the sensor clock signal CKLi are also transmitted to the sensor scanning driver 700.

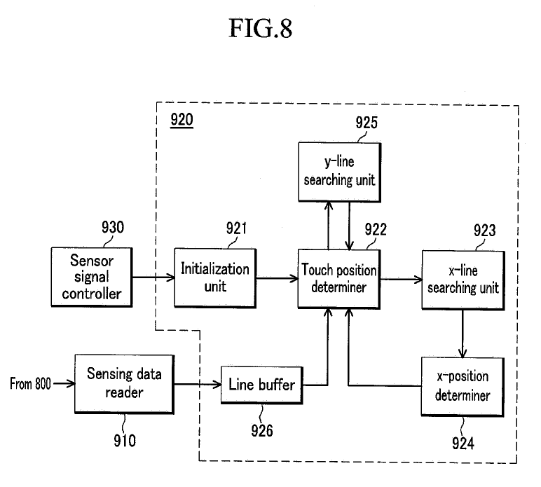

The touch position determining unit 920 confirms the start of one sensor frame in response to the sensor scanning start signal STVi and reads the sensing data SENSOR from the line buffer of the sensing data determining unit 910 according to the sensor clock signal CLKi to store it to a line buffer (926 of FIG. 8). The touch position determining unit 920 sequentially processes the sensing data of one row to determine whether there are a number of touch regions during one sensing frame and the positions of each of the touch regions. After these determinations, the touch position determining unit 920 outputs the data representing the x-axis position xi_pos and the y-axis position yi_pos of each touch region to the touch position transmitter 940. If it is assumed that the liquid crystal display according to an exemplary embodiment of the present invention determines a maximum of 10 touch regions, and i is an integer of from 1 to 10. Thus, the touch position determining unit 920 outputs the data touch_cnt_o[i] representing whether a touch is substantially generated among the 10 touch regions to the touch position transmitter 940.

The touch position transmitter 940 outputs the data transmitted from the touch position determining unit 920 to the sensor scanning driver 700 or the external controller to provide information on whether a touch is generated in one of the regions.

Next, the operation of the touch position determining unit 920 shown in FIG. 7 is described in detail with reference to FIG. 8 to FIG. 13.

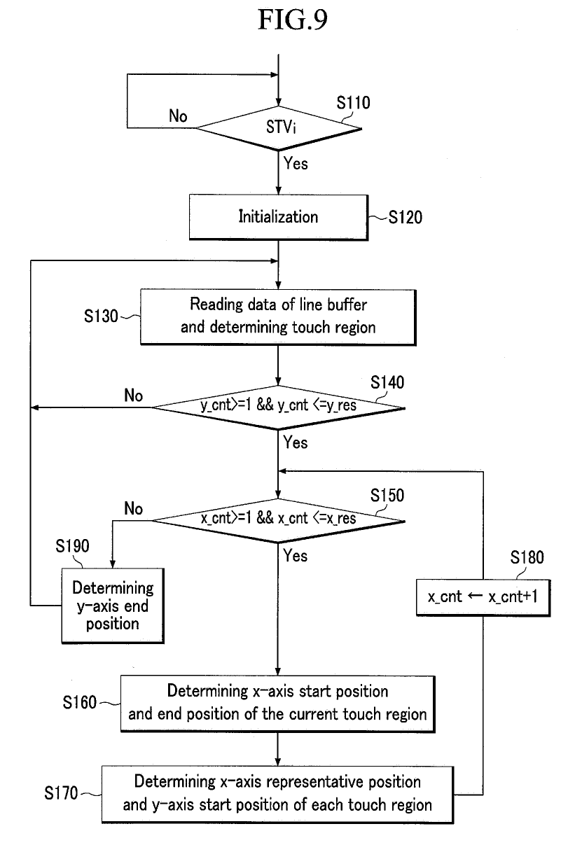

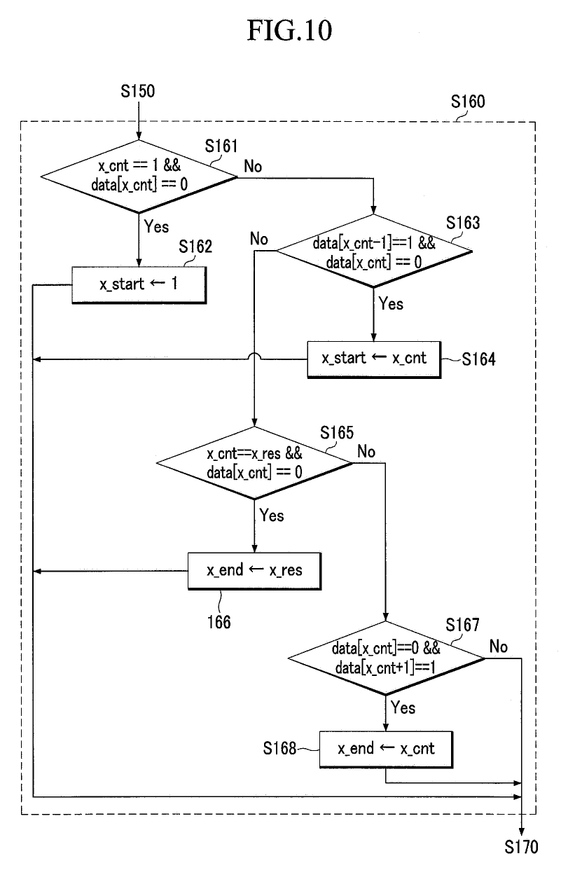

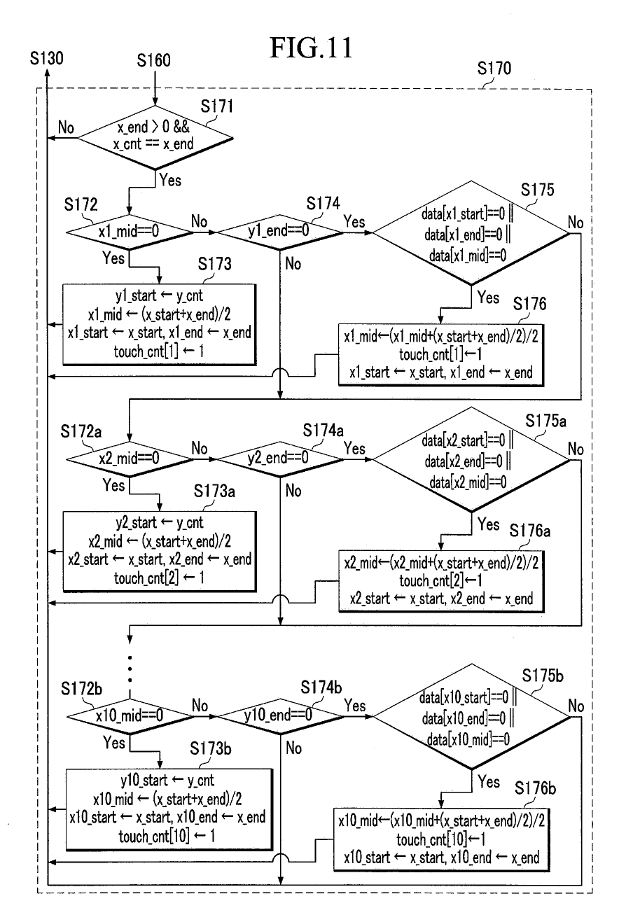

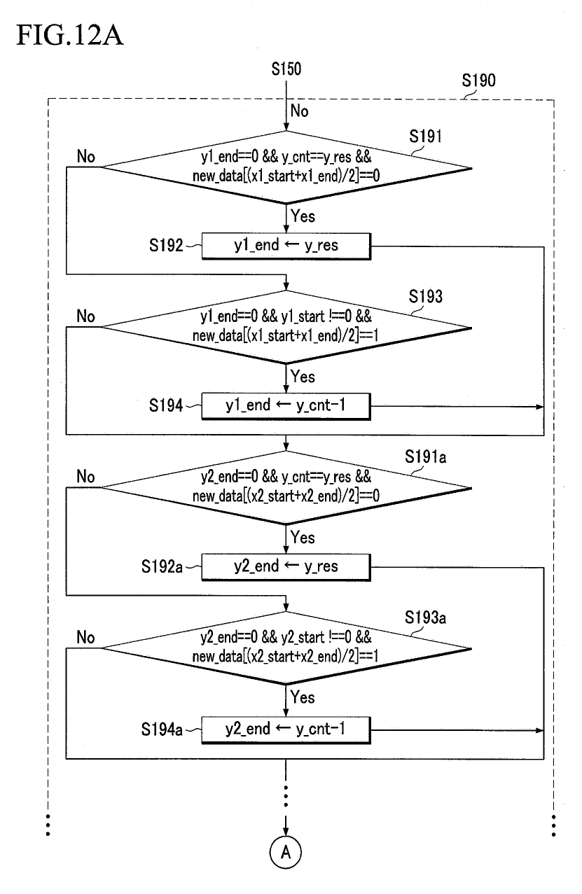

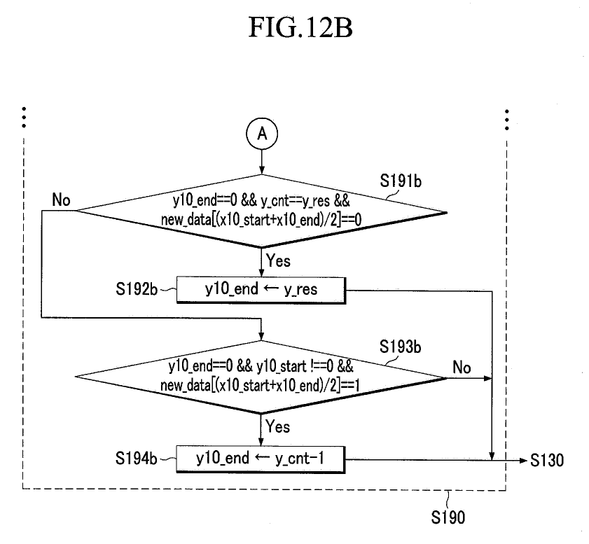

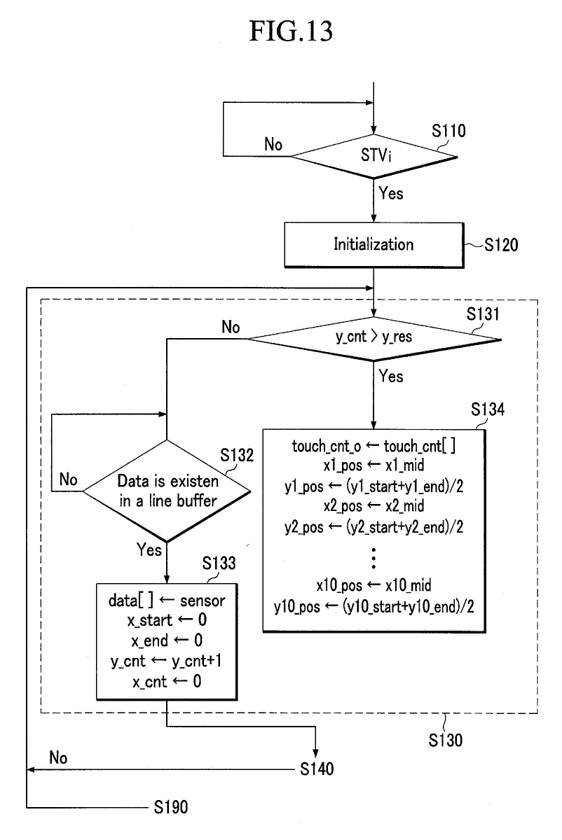

FIG. 8 is a block diagram of a touch position determining unit 920 according to an exemplary embodiment of the present invention. FIG. 9 is a flowchart showing a method for determining the touch position of the touch position determining unit shown in FIG. 8. FIG. 10 is a flowchart showing a method for determining a starting position and an ending position of an x-axis in the touch position determining unit 920 of FIG. 8. FIG. 11 is a flowchart showing a method for determining a representative position of x-axis and a starting position of a y-axis in the touch position determining unit 920 shown in FIG. 8. FIG. 12A and FIG. 12B are flowcharts showing a method for determining an ending position of the y-axis in the touch position determining unit 920 shown in FIG. 8. FIG. 13 is a flowchart showing a method for determining a touch region position in the touch position determining unit 920 shown in FIG. 8.

As shown in FIG. 8, the touch position determining unit 920 includes an initialization unit 921, a touch position determiner 922, an x-line searching unit 923, an x-position determiner 924, a y-line searching unit 925, and a line buffer 926.

Referring to FIG. 9, if the initialization unit 921 of the touch position determining unit 920 receives the sensor scanning start signal STVi from the sensor signal controller 930 (S110), the initialization unit 921 initialize the sensor parameter (S120). Here, the sensor parameter includes a parameter representing the positions of each touch region, a parameter data[x_cnt] representing the value of the sensing data in the x-line (hereinafter referred to as “sensing data”), a parameter touch_cnt[i] representing whether the touch is generated or not (hereinafter referred to as “touch determining data”), a parameter x_cnt representing the x-axis position of the current sensing data (hereinafter referred to as “x-axis position”) and a parameter y_cnt representing the y-axis position of the current sensing data (hereinafter referred to as “y-axis position”). The parameter representing the position of each touch region includes a start position xi_start in the x-axis, a end position xi_end in the x-axis, a representative position xi_mid in the x-axis, a start position yi_start in the y-axis, and a end position yi_end in the y-axis. Here, the initialization unit 721 sets all parameters except for the sensing data data [symbol] to ‘0’ and the sensing data data [symbol] to ‘1’. A sensing data data [symbol] having a value of 1 indicates the absence of a touch.

Next, if the sensing data of one sensor frame are not all read, the touch position determiner 922 of the touch position determining unit 920 stores the sensing data SENSOR stored to the line buffer of the sensing data reader 910 to the line buffer 926 (S130). By transmitting the sensing data of one row stored to the line buffer to line buffer 926 of the touch position determining unit 920, the sensing data of the next row can be stored to the line buffer.

Subsequently, the touch position determiner 922 determines whether the y-axis position y_cnt of the sensing data data[1:x_res] stored to the line buffer 926 is in the range of the y-axis resolution y_res (S140). If the y-axis position y_cnt is in the range of the y-axis resolution y_res, the x-line searching unit 923 determines whether the current x-axis position x_cnt is in the range of the x-axis resolution x_res (S150).

Here, if the x-axis position x_cnt of the sensing data data[x_cnt] is in the range of the x-axis resolution, the x-line searching unit 923 searches the sensing data data[1:x_res] corresponding to one row to determine the x-axis start position x_start and the x-axis end position x_end of the searched touch region (S160). Next, the x-position determiner 924 determines the x-axis representative position xi_mid in the searched touch region by using the x-axis start position x_start and the x-axis end position x_end, and determines the y-axis position in which the x-axis representative position is initially determined as the y-axis start position yi_start in the corresponding touch region (S170). Then, the x-line searching unit 923 changes the x-axis position x_cnt into the next position x_cnt+1 (S180), and the process is repeated from the step S150.

If the current x-axis position x_cnt deviates from the range of the x-axis resolution x_res (S150), the y-line searching unit 925 confirms whether the current y-axis position of the searched touch region is the y-axis end position yi_end to determine the y-axis end position yi_end (S190). Next, the touch position determiner 922 reads the next sensing data from the line buffer of the sensing data reader 910 to store the next sensing data to the line buffer 926 (S130), and the process is repeated from the step S140. Here, when the sensing data of one sensor frame have been read and processed, the touch position determiner 922 determines the final position xi_pos and yi_pos of each touch region by using the x-axis representative position xi_mid, the y-axis start position yi_start, and the y-axis end position yi_end in each touch region, which are determined through the process from the step S140 to the step S190 (S130).

Next, the operations of the x-line searching unit 923, the x-position determiner 924, the y-line searching unit 925 and the touch position determiner 922 is described in detail in steps of S160, S180, S190, and S130 with reference to FIG. 10 to FIG. 13.

Referring to FIG. 10, the x-line searching unit 923 determines the position at which the sensing data data[x_cnt] is changed from ‘1’ into ‘0’ in the row corresponding to the y-axis position y_cnt as the position of the beginning of the touch region, and sets this position as the x-axis start position x_start of the current touch region. However, because no previous sensing data exists when a touch occurs in the first column x_cnt=1, when the sensing data data[1] of the first column is ‘0’, the first column x_cnt=1 is determined as the x-axis start position x_start.

When the current x-axis position x_cnt is ‘1’ and the sensing data data[x_cnt] is ‘0’ in the row corresponding to the y-axis position y_cnt (S161), the x-line searching unit 923 determines the x-axis start position x_start as ‘1’ (S162). Otherwise, the x-line searching unit 923 compares the values of the previous sensing data data[x_cnt−1] and the current sensing data data[x_cnt] (S163). If the previous sensing data data[x_cnt−1] is ‘1’ and the current sensing data data[x_cnt] is ‘0’, the x-line searching unit 923 determines the current x-axis position x_cnt as the x-axis start position x_start (S164).

On the other hand, if the previous sensing data data[x_cnt−1] is not ‘1’ or the current sensing data data[x_cnt] is not ‘0’ (S163), the x-line searching unit 923 determines the x-axis end position x_end. Here, the x-line searching unit 923 determines the position at which the sensing data data[x_cnt] is changed from ‘0’ to ‘1’ in the row corresponding to the current y-axis position y_cnt as the x-axis end position x_end of the current touch region. However, because no next sensing data exists in when a touch occurs in the final column x_cnt=x_res, if the final sensing data data[x_res] is ‘0’, the final column x_cnt=x_res is determined as the x-axis end position x_end.

For this, if the current x-axis position x_cnt is the final column x_res and the sensing data data[x_cnt] is ‘0’ (S165), the x-line searching unit 923 determines the x-axis end position x_end as the final column x_res (S166). Otherwise, the x-line searching unit 923 confirms the values of the current sensing data data[x_cnt] and the next sensing data data[x_cnt+1] (S167). If the current sensing data data[x_cnt] is ‘0’ and the next sensing data data[x_cnt+1] is ‘1’ (S167), the x-line searching unit 923 determines the x-axis end position x_end as the x-axis position x_cnt of the current sensing data (S168). Also, when the current sensing data data[x_cnt] is not ‘0’ or the next sensing data data[x_cnt+1] is not ‘1’ (S167), the current position is not the touch region or the touch region has not ended. Accordingly, the x-axis position is changed into the next position through the steps of S170 and S180.

Next, the x-position determiner 924 renews the x-axis representative position xi_mid of the touch region by using the x-axis start position x_start and the x-axis end position x_end determined in the step of S160 and determines the y-axis start position yi_start (S170).

In detail, referring to FIG. 11, the x-position determiner 924 determines whether the x-axis end position x_end has been determined in the current x-axis position x_cnt, that is, whether the x-axis end position x_end is more than 0 and the current x-axis position x_cnt is the same as the x-axis end position x_end (S171). If the x-axis end position x_end has been determined in the current x-axis position x_cnt, then the boundary has been fixed in a row direction (the x-axis direction) of the touch region. Accordingly, if the touch region of which the boundary is fixed in the row direction is continuous with the neighboring touch region in the column direction (the y-axis direction), the x-position determiner 924 renews the position of the touch region; otherwise, it sets a new touch region. As above-described, it is assumed that the liquid crystal display recognizes a maximum of 10 touch regions (the first to tenth touch regions).

In detail, firstly the x-position determiner 924 confirms whether the x-axis representative position x1_mid of the first touch region is already determined (S172). When the x-axis representative position x1_mid of the first touch region is not determined, that is, the x-axis representative position x1_mid is ‘0’, because the current y-axis position is an initial position for the first touch region, the x-position determiner 924 determines the current y-axis position y_cnt as the y-axis start position y1_start of the first touch region (S173). The x-position determiner 924 determines the representative values of the start position x_start and the x-axis end position x_end. For example, the average values are determined to be the x-axis representative position x1_mid of the first touch region, and the start position x_start and the x-axis end position x_end are determined to be the start position x1_start and the x-axis end position x1_end of the first touch region (S173). Also, the x-position determiner 924 sets the touch determining data touch_cnt[1] as ‘1’ to represent the generation of the first touch region (S173). When the position of the first touch region is determined after or the x-axis end position is not yet determined, the x-line searching unit 923 changes the x-axis position x_cnt to the next position (S180), and the operation of the step of S150 is again executed.

On the other hand, when the x-axis representative position x1_mid of the first touch region is already determined (S172), the x-position determiner 924 determines whether the column direction boundary of the first touch region has already been fixed, and whether the current touch region is continuous with the first touch region if the column direction boundary of the first touch region has been not fixed. To do this, the x-position determiner 924 first determines whether the y-axis end position y1_end of the first touch region is already determined, that is, the y-axis end position y1_end is not ‘0’ (S174). If the y-axis end position y1_end is ‘0’ because the first touch region is not fixed, the x-position determiner 924 determines the values of the sensing data in the current y-axis position corresponding to the x-axis start position x1_start, the x-axis end position x1_end, and the x-axis representative position x1_mid of the determined first touch region (S175). If at least one among the sensing data data[x1_start], data[x1_end], and data[x1_mid] is ‘0’, the x-position determiner 924 determines the current touch region to be continuous with the first touch region. That is, if at least the row direction boundary of the touch region of the previous row matches the portion of the row direction boundary of the touch region searched in the current row, it is determined that two touch regions are continuous with each other. Also, the x-position determiner 924 renews the x-axis representative position x1_mid as the representative value. For example, the average value of the previous x-axis representative position x1_mid is renewed with and the average value of the current start position x_start and the x-axis end position x_end (S176). Also, the x-position determiner 924 respectively renews the x-axis start position x1_start and the x-axis end position x1_end of the first touch region as the current x-axis start position and end position x_start and x_end, and maintains the touch determining data touch_cnt[1] as ‘1’ because the first touch region is continuous (S176). Also, the x-line searching unit 923 changes the x-axis position x_cnt into the next position (S180), and executes the operation of the step S150 again. Accordingly, it can be determined whether the touch regions processed by the row unit are continuous. In addition, when the touch regions are continuous, the representative value of the x-axis representative position that is already determined and the x-axis representative position that is current determined is renewed as the x-axis representative position in the continuous case such that the x-axis position of the continuous touch regions can be determined.

On the other hand, if the first touch region has already been determined in the step S174 or S175, or the current touch region and the first touch region are not continuous to each other, the x-position determiner 924 determines that a second touch region that is different from the first touch region is generated, and determines the position of the second touch region. To do this, the x-position determiner 924 processes the operations corresponding to the steps from S172 to S176 for the second touch region (S172a-S176a). Also, when the new touch region is continuously generated, the x-position determiner 924 processes the operations corresponding to the steps from S172 to S176 to the tenth touch region (S172b-S176b).

Next, after repeating the operation of steps S160 and S170 while changing the x-axis position (S180), the y-line searching unit 925 fixes the y-axis position of each touch region if the x-axis position deviates from the x-axis resolution range (S150). That is, the y-line searching unit 925 determines the y-axis end position when the y-axis end position of each touch region is not determined (S190). When a touch occurs (i.e., the sensing data is ‘1’) in the current y-axis position of the representative position (for example the middle position) of the x-axis start position xi_start and the x-axis end position xi_end, the y-line searching unit 925 determines the previous y-axis position as the final touch position.

In detail, referring to FIG. 12A and FIG. 12B, if the y-axis end position y1_end of the first touch region is not yet determined, the current y-axis position y_cnt is the final position y_res and the sensing data of the middle position of the x-axis start position x1_start and end position x1_end is ‘0’ (S191), the y-line searching unit 925 determines the y-axis final position y_res as the y-axis end position y1_end of the first touch region (S192). That is, when the touch regions are continuous until the final row, where no next row exists, the final row is determined as the y-axis end position.

Otherwise, when the y-axis end position y1_end is ‘0’, the y-axis start position y1_start is not ‘0’, and the sensing data data[(x1_start+x1_end)/2] of the middle position of the x-axis start position and end position x1_start and x1_end is ‘1’ (S193), the y-line searching unit 925 determines the previous y-axis position y_cnt−1 as the y-axis end position y1_end (S194). That is to say, when the y-axis end position is not yet determined and a touch does not occur in the x-axis middle position in the state in which the y-axis start position is determined, the y-line searching unit 925 determines that the first touch region has ended in the previous y-axis position.

After determining the y-axis end position y1_end of the first touch region in step S192 or S194 or if the first touch region is not fixed, in the step of S193, the y-line searching unit 925 determines the y-axis end position y2_end for the second touch region. To do this, the y-line searching unit 925 processes the operations corresponding to from S191 to S194 for the second touch region (S191a-S194a). The y-line searching unit 925 processes the operations corresponding to from S191 to S194 until the tenth touch region (S191b-S194b). As described, if a touch does not occur in the position of the current row corresponding to the representative position of the previous row in each touch region, the previous row is determined as the final position of the column direction such that the boundary of the column direction (y-axis direction) of each touch region can be determined.

Next, the touch position determiner 922 determines the final position of each touch region by using the information determined in steps S160, S180, and S190 (S130).

Referring to FIG. 13, when the touch position determiner 922 has not searched the sensing data of all rows corresponding to one sensor frame (S131), it determines whether the sensing data is present in the line buffer of the sensing data reader 132 (S132). When the sensing data is not present in the line buffer of the sensing data reader 132, the touch position determiner 922 waits until the new sensing data are stored to the line buffer. When the sensing data is present in the line buffer of the sensing data reader 132, the touch position determiner 922 reads the sensing data of the line buffer of the sensing data reader 132, stores it to the line buffer 926, and changes the y-axis position into the next position y_cnt+1 (S133). Also, the touch position determiner 922 initializes the x-axis start position x_start, the x-axis end position x_end, and the x-axis position x_cnt, to process the sensing data of the row corresponding to the changed y-axis position (S133).

After searching the sensing data of all rows corresponding to the sensor frame (S131), the touch position determiner 922 determines the position of the touch region by using the x-axis representative position xi_mid, the y-axis start position yi_start, and the y-axis end position yi_end, which are determined for each touch region, and the touch determining data touch_cnt[i] of each touch region (S134). The touch position determiner 922 determines the x-axis representative position xi_mid of each touch region as the x-axis position, that is, the position xi_pos in the row direction, and the representative value of the y-axis start position and end position yi_start and yi_end of each touch region as the y-axis position, that is, the position yi_pos in the column direction. Here, the average value may be used as the representative value. Also, the touch position determiner 922 determines the touch determining data touch_cnt[i] as the touch determining data touch_cnt_o[i] for the transmission, and the number of the touch determining data touch_cnt[i] having the value of ‘1’ is the number of the touch regions generated during one sensor frame.

Accordingly, in the exemplary embodiment of the present invention, the number of touch regions generated during one sensor frame and the position of each touch region can be independently determined, and the positions of the touch regions can be determined by two line buffers as a substitution of a frame buffer. Also, the positions of all touch regions generated in one sensor frame can be determined during sequential processing of the sensing data of one sensor frame by row, thereby reducing the processing time required for to determine the position of the touch region.

Above, a liquid crystal display was described as the display device in an exemplary embodiment of the present invention. However, the present invention is not limited thereto. The present invention can be equivalently applied to other flat panel display devices such as a plasma display or an organic light emitting display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of sensor scanning lines extending in a first direction and sequentially receiving a first voltage;
a plurality of sensor data lines extending in a second, different, direction;
a plurality of sensing elements respectively formed in regions defined by the sensor scanning lines and the sensor data lines, and configured to transmit the first voltage from an associated sensor scanning line among the plurality of sensor scanning lines to an associated sensor data line among the plurality of sensor data lines according to an external touch;
a sensing signal processor configured to convert voltages of the sensor data lines into sensing data; and
a touch determining unit configured to determine positions of touch regions receiving external touches during at least one frame by processing sensing data for at least one sensor scanning line, wherein sensing data for at least one sensor scanning line is generated by sensing elements connected to one of the plurality of scanning lines.

2. The display device of claim 1, further comprising:
a plurality of sensor gate lines;
an sensor scanning driver configured to sequentially transmit a gate-on voltage to the sensor gate lines;
a plurality of switching elements, each switching element having an input terminal corresponding to a signal line for supplying the first voltage, a control terminal corresponding to the sensor gate line, and an output terminal corresponding to the sensor scanning line, wherein each switching element is configured to be turned on in response to the gate-on voltage transmitted to the control terminal.

3. The display device of claim 1, wherein the touch determining unit comprises:
a sensing data reader configured to receive and store the sensing data of at least one scanning line from the sensing signal processor; and
a touch position determining unit configured to read the sensing data of at least one scanning line stored in the sensing data reader to determine the positions of the touch regions, wherein the sensing data reader is configured to receive and store the sensing data of at least one next scanning line from the sensing signal processor after the touch position determining unit reads the sensing data of the at least one scanning line.

4. The display device of claim 3, wherein the touch position determining unit is configured to determine the number of touch regions generated during at least one frame and the position of each touch region.

5. The display device of claim 1, wherein the sensing signal processor is configured to maintain the voltage of a sensor data line not receiving the first voltage with a second voltage different from the first voltage, generate a sensing data with a first value when the sensor data line has the first voltage, and generate a sensing data to a second value when the sensor data line has the second voltage.

6. The display device of claim 5, wherein the sensing signal processor includes a plurality of resistors, at least one of which is connected between each of the sensor data lines and a voltage source supplying the second voltage.

7. The display device of claim 5, wherein the touch determining unit is configured to determine a first start position and a first end position in the column direction of each touch region generated during at least one frame, and determine a representative value from the first start position and the first end position as a position in the second direction.

8. The display device of claim 7, wherein the touch determining unit is configured to determine a representative position in each scanning line corresponding to each touch region, and determine a representative value of the representative positions in the sensor scanning lines corresponding to each touch region as a position in the first direction.

9. The display device of claim 8, wherein the touch determining unit is configured to determine a second start position and a second end position in each scanning line of each touch region, and determine a representative value from the second start position and the second end position as the representative position of each scanning line.

10. The display device of claim 9, wherein the representative value is the average value.

11. The display device of claim 9, wherein the touch determining unit is configured to determine a position at which the sensing data is changed from the second value to the first value in each scanning line as the second start position, and determines a position at which the sensing data is changed from the first value to the second value as the second end position.

12. The display device of claim 8, wherein the touch position determining unit is configured to search each scanning line of sensing data to determine the first start position and the first end position of each touch region.

13. The display device of claim 12, wherein the touch position determining unit is configured to determine a position of a scanning line at which the representative position is first determined in each touch region as the first start position.

14. The display device of claim 12, wherein the touch position determining unit is configured to determine a previous scanning line as the first end position when the sensing data of a current scanning line corresponding to the representative position of the previous scanning line in each touch region is the second value.

15. The display device of claim 12, wherein when the first end position is not determined in each touch region and at least one among the sensing data of a current scanning line respectively corresponding to the second start position, the second end position, and the representative position of a previous scanning line is the first value, the touch position determining unit is configured to set the representative position of the current scanning line to be within the same touch region as the representative position of the previous scanning line.

16. A method of driving a display device including a plurality of sensor scanning lines extending in a first direction, a plurality of sensor data lines extending in a second direction, and a plurality of sensing elements formed in the regions defined by the sensor scanning lines and the sensor data lines and connected to a corresponding sensor scanning line and a corresponding sensor data line, the method comprising:
sequentially applying a reference voltage to the sensor scanning lines;
transmitting the reference voltage from a sensor scanning line connected to a sensing element receiving an external touch to a sensor data line connected to the sensing element;
converting voltages of the sensor data lines into sensing data; and
determining positions of touch regions generated during one frame by processing the sensing data by one scanning line.

17. The method of claim 16, wherein the conversion of the voltages comprises:
generating a sensing data having a first value when the voltage of a sensor data line is the reference voltage; and
generating a sensing data having a second value when the voltage of a sensor data is not the reference voltage.

18. The method of claim 17, wherein the determination of the positions comprises:
searching the sensing data sequentially in the first direction to detect a start of a first touch region;
determining a position of the first touch region in the second direction; and
determining a position of the first touch region in the first direction.

19. The method of claim 18, wherein the determination of the position in the second direction comprises:
determining a first start position and a first end position of the first touch region in the second direction; and
determining a representative value of the first start position and the first of the first touch region end position as the position in the second direction; and
further wherein the determination of the position in the first direction comprises:
determining a representative position of the first touch region in each scanning line; and
determining a representative value of the representative positions in scanning lines of the first touch region as the position of the first touch region in the first direction.

20. The method of claim 19, wherein the determination of the representative position comprises:
determining a second start position and a second end position of the first touch region in each scanning line; and
determining a representative value of the second start position and the second end position as the representative position.

21. The method of claim 20, wherein the determination of the second start position and the second end position comprises:
determining a position at which the sensing data is changed from the second value to the first value in each scanning line of the first touch region as the second start position; and
determining a position at which the sensing data is changed from the first value to the second value in each scanning line of the first touch region as the second end position.

22. The method of claim 20, wherein the determination of the first start position and the first end position comprises determining a scanning line at which the representative position is firstly determined in the first touch region as the first start position.

23. The method of claim 20, wherein the determination of the first start position and the first end position comprises determining a previous scanning line as the first end position when the sensing data of a current scanning line corresponding to the representative position of the previous scanning line in the first touch region is the second value.

24. The method of claim 20, wherein the determination of the positions further comprises determining the representative position of a current scanning line to be included in the first touch region if at least one among the sensing data of the current scanning line corresponding to the second start position, the second end position, and the representative position of a previous scanning line has the first value when the first end position is not determined in the first touch region.

25. The method of claim 20, wherein the determination of the positions further comprises determining the representative position of a current scanning line to be within a second touch region that is different from the first touch region if the sensing data of the current scanning line corresponds to the second start position, the second end position, and the representative position of a previous scanning line have the second value and the first end position is not determined in the first touch region.
